(19) United States
(12) Patent Application Publication
(10) Pub. No.: US 2011/0142004 A1
(43) Pub. Date: Jun. 16, 2011

(54) SMALL BASE STATION APPARATUS AND CELL SEARCH METHOD

(75) Inventors: Hyung Deug BAE, Daejeon (KR); Sang Chul OH, Daejeon (KR); Jun Sik KIM, Daejeon (KR); Seung-Que LEE, Daejeon (KR); Nam Hoon PARK, Daejeon (KR)

(73) Assignee: Electronics and Telecommunications Research Institute, Daejeon (KR)

(21) Appl. No.: 12/837,839

(22) Filed: Jul. 16, 2010

(30) Foreign Application Priority Data
Dec. 15, 2009 (KR) 10-2009-0124945

(51) Int. Cl. H04W 4/00

(52) U.S. Cl. 370/331

(57) ABSTRACT

A small base station apparatus includes: a communication unit for collecting system information of a neighboring cell through mobile communication terminals being connected to a cell of the small base station apparatus; a memory unit for storing the system information of the neighboring cell; and a controller for checking whether or not a mobile communication terminal is allowed a handover connection to the neighboring cell based on the system information of the neighboring cell, registering the neighboring cell in a handover candidate list of the mobile communication terminal if the mobile communication terminal is allowed the handover connection, selecting one of neighboring cells registered in the handover candidate list, and performing handover of the mobile communication terminal to the selected neighboring cell.

### CROSS-REFERENCE(S) TO RELATED APPLICATION(S)

The present invention claims priority of Korean Patent Application No. 10-2009-0124945, filed on Dec. 15, 2009, which is incorporated herein by reference.

### FIELD OF THE INVENTION

The present invention relates to a method for searching a cell for handover in a base station in a mobile communication system; and, more particularly, to a small base station apparatus capable of performing more stable handover, and a method for searching a cell for handover of a mobile communication terminal in the small base station apparatus.

### BACKGROUND OF THE INVENTION

A micro base station or a femtocell base station uses a room space in a house or an office as a service coverage for super high-speed data transmission. Such small private base station (hereinafter, referred to as a ‘small base station’), owned by an individual or a company, is called a home base station, a home eNodeB, a femto eNodeB, and the like.

The small base station includes an open base station, a closed base station, and a hybrid base station depending on an access mode. The base station in the closed or hybrid access mode has its own closed subscriber group (CSG) ID.

The features of the small base station depending on each access mode will be described below.

The base station in the open access mode allows an access by every mobile communication terminal within its cell coverage. The base station in the closed access mode allows an access by only mobile communication terminals whose CSG IDs are within a CSG ID list of the base station, among the mobile communication terminals within its cell coverage. The base station in the hybrid access mode allows an access by every mobile communication terminal but gives more priorities in terms of an access or a resource allocation to a subscriber terminal, which has been registered as a member, with a CSG ID in the CSG ID list of the base station, compared with a non-member subscriber terminal.

Meanwhile, in the small base station, when load balancing is required due to an increase in the load of the base station, when the usage term of a temporary CSG ID of a mobile communication terminal expires, or the like, a need may exist to perform handover of the mobile communication terminal to a base station of a neighboring cell.

However, in the related art, when handover of the mobile communication terminal to a base station of a neighboring cell needs to be performed for those reasons, such as the load balancing required due to the increase in the load of the base station or the expiration of the usage term of the temporary CSG ID of the mobile communication terminal, the source base station attempts handover of the mobile communication terminal without the knowledge of an access mode of the target base station, causing a problem in that the attempted handover is rejected by the target cell.

### SUMMARY OF THE INVENTION

In view of the above, the present invention provides a small base station apparatus, which serves as a source base station that performs cell searching for handover of a mobile communication terminal, which establishes a handover candidate list including neighboring cells allowing handover of the mobile communication terminal by analyzing system information of neighboring cells collected from the mobile communication terminal, and then selects one of base stations included in the handover candidate list and attempts handover when a handover event with respect to the mobile communication terminal occurs, thereby performing more stable handover by reducing a handover rejection rate by a target cell, and a cell search method for handover of a mobile communication terminal in the small base station apparatus.

In accordance with a first aspect of the present invention, there is provided a small base station apparatus, including:

a communication unit for collecting system information of a neighboring cell through mobile communication terminals being connected to a cell of the small base station apparatus;

a memory unit for storing the system information of the neighboring cell; and

a controller for checking whether or not a mobile communication terminal is allowed a handover connection to the neighboring cell based on the system information of the neighboring cell, registering the neighboring cell in a handover candidate list of the mobile communication terminal if the mobile communication terminal is allowed the handover connection, selecting one of neighboring cells registered in the handover candidate list, and performing handover of the mobile communication terminal to the selected neighboring cell.

In accordance with a second aspect of the present invention, there is provided a method for searching a cell for handover in a small base station apparatus, the method including:

collecting system information of a neighboring cell through mobile communication terminals being connected to a cell of the small base station apparatus;

storing the system information of the neighboring cell;

establishing a handover candidate list for handover of a mobile communication terminal based on the system information of the neighboring cell; and

selecting, when a handover event with respect to the mobile communication terminal occurs, one of neighboring cells registered in the handover candidate list, and performing handover of the mobile communication terminal to the selected neighboring cell.

### BRIEF DESCRIPTION OF THE DRAWINGS

The objects and features of the present invention will become apparent from the following description of embodiments given in conjunction with the accompanying drawings, in which:

FIG. 1 is a conceptual view of collecting, by a small base station, system information of a neighboring cell in accordance with an embodiment of the present invention;

FIG. 2 illustrates a schematic block diagram of the small base station in accordance with the embodiment of the present invention;

FIG. 3 is a flowchart illustrating a process of collecting, by the small base station, system information of a mobile communication terminal and a neighboring cell, in accordance with the embodiment of the present invention;

FIG. 4 is a flowchart illustrating a process of making, by the small base station, a handover candidate list of a neighboring cell suitable for handover of the mobile communication terminal, in accordance with an embodiment of the present invention; and

FIG. 5 is a flowchart illustrating a process of performing, by the small base station, handover of the mobile communication terminal in accordance with an embodiment of the present invention.

### DETAILED DESCRIPTION OF THE EMBODIMENTS

Hereinafter, embodiments of the present invention will be described in detail with the accompanying drawings which form a part hereof.

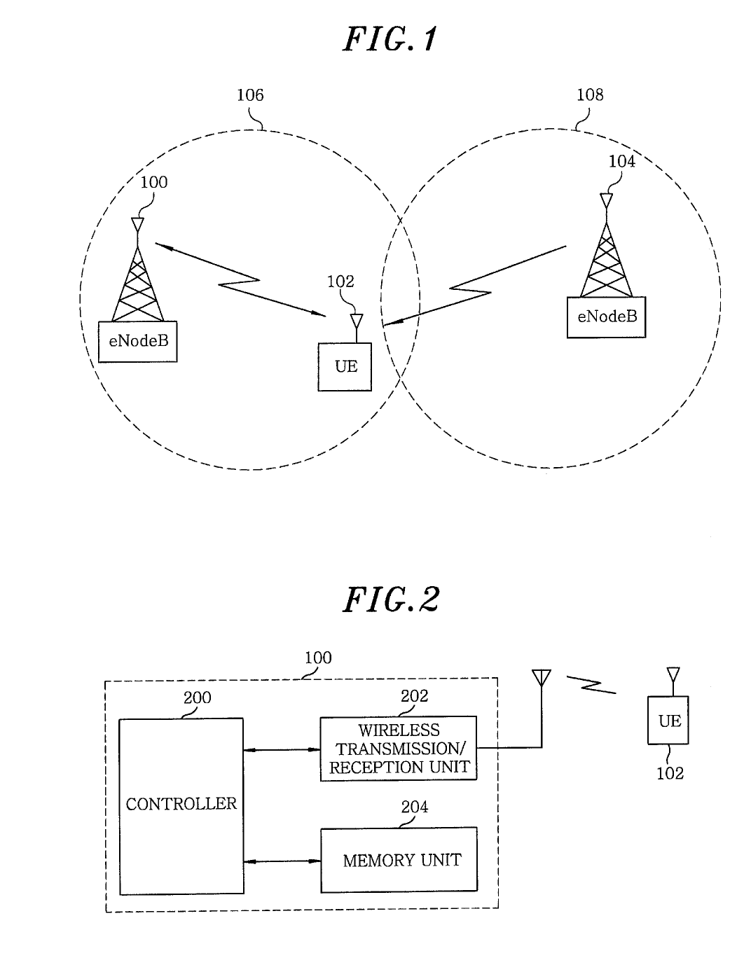

FIG. 1 shows a conceptual view of collecting, by a small base station such as a femtocell base station, system information of a neighboring cell in accordance with an embodiment of the present invention.

Referring to FIG. 1, a small base station 100 refers to a small private base station such as a femtocell base station or the like that covers a room space in a house or an office as a service area for super high-speed data transmission. The small base station (eNodeB) 100 periodically broadcasts system broadcast information to a user equipment (UE) 102, i.e., a mobile communication terminal to which it provides a mobile communication service within its cell 106. The UE 102 acquires information regarding an eNodeB 104 within a neighboring cell 108 through system broadcast information being broadcasted from the eNodeB 104 existing within a signal receivable area as well as from the eNodeB 100 to which the UE 102 is being currently connected. Here, the information regarding the eNodeB 104 within the neighboring cell 108 includes an access mode of the eNodeB 104 and CSG ID list information thereof.

The eNodeB 100 requests the information regarding the eNodeB 104 within the neighboring cell 108 of the UE 102 in accordance with the embodiment of the present invention.

In this way, the UE 102 reports the collected information regarding the eNodeB 104 within the neighboring cell 108 to the eNodeB 100 within the cell 106 to which the UE 102 itself is being currently connected. Also, the UE 102 has its own CSG ID information. The UE 102 provides its CSG ID information to the eNodeB 100 on request by the eNodeB 100.

FIG. 2 illustrates a schematic block diagram of the small base station apparatus (i.e., eNodeB 100) such as a femtocell base station in accordance with the embodiment of the present invention. The eNodeB 100 includes a wireless transmission/reception unit 202, a memory unit 204, and a controller 200.

Now, the operation of each component of the eNodeB 100 will be described in detail.

First, the wireless transmission/reception unit 202 uses a transceiver structure including separate transmission and reception paths based on a frequency division duplex (FDD) scheme of a mobile communication system protocol such as wideband code division multiple access (WCDMA) and the like.

The wireless transmission/reception unit 202 receives a radio signal transmitted from a nearby macro base station (not shown) for a sniffer function of the eNodeB 100. To this end, the wireless transmission/reception unit 202 may form a UE signal reception path and an eNodeB signal reception path by using a single wireless reception unit. The eNodeB 100 synchronizes its downlink channel with a downlink channel of the macro base station based on information received via the eNodeB signal reception path, and acquires its cell information to recognize its cell coverage.

The controller 200 controls the entire operation of the eNodeB 100 depending on an operation program of the eNodeB 100 stored in the memory unit 204. Basically, the controller 200 controls such that one wireless reception unit included in the wireless transmission/reception unit 202 establishes the UE signal reception path, and if necessary, also controls such that the corresponding wireless reception unit establishes the eNodeB signal reception path.

The eNodeB 100 requests CSG ID information of the UE 102 to the UE 102, and stores the received CSG ID information of the UE 102 in the memory unit 204.

Also, the eNodeB 100 requests the UE 102 to collect base station (eNodeB 104) information within the neighboring cell 108, receives the base station information within the neighboring cell 108, and stores the same in the memory unit 204.

When the information of the eNodeB 104 within the neighboring cell 108 is received through the UE 102 that is providing service within the cell 106 of the eNodeB 100, the controller 200 checks whether or not the eNodeB 104 is a base station allowing a handover connection (or handover access) of the UE 102 by analyzing the information regarding the eNodeB 104 within the neighboring cell 108.

When the eNodeB 104 is checked to be a base station allowing a handover connection of the UE 102, the controller 200 registers the corresponding base station in a handover candidate list of the UE 102 to establish the handover candidate list, and then when a handover event of the UE 102 such as load balancing, the expiration of a temporary CSG ID usage term, or the like occurs, the controller 200 selects one of base stations registered in the handover candidate list and performs handover of the UE 102, thereby reducing a handover rejection possibility by a target cell and performing handover of the UE 102 more stably.

In this case, in checking whether or not the eNodeB 104 within the neighboring cell 108 is a base station allowing a handover connection of the UE 102, the controller 200 analyzes information regarding an access mode of the eNodeB 104 among the information regarding the eNodeB 104. If the access mode of the eNodeB 104 is an open or hybrid access mode, the controller 200 registers the corresponding eNodeB 104 in the handover candidate list. Meanwhile, if the access mode of the eNodeB 104 is a closed access mode, when the CSG ID list among the information regarding the eNodeB 104 within the neighboring cell 108 includes a CSG ID of the UE 102, the controller 200 registers the corresponding base station (eNodeB 104) in the handover candidate list.

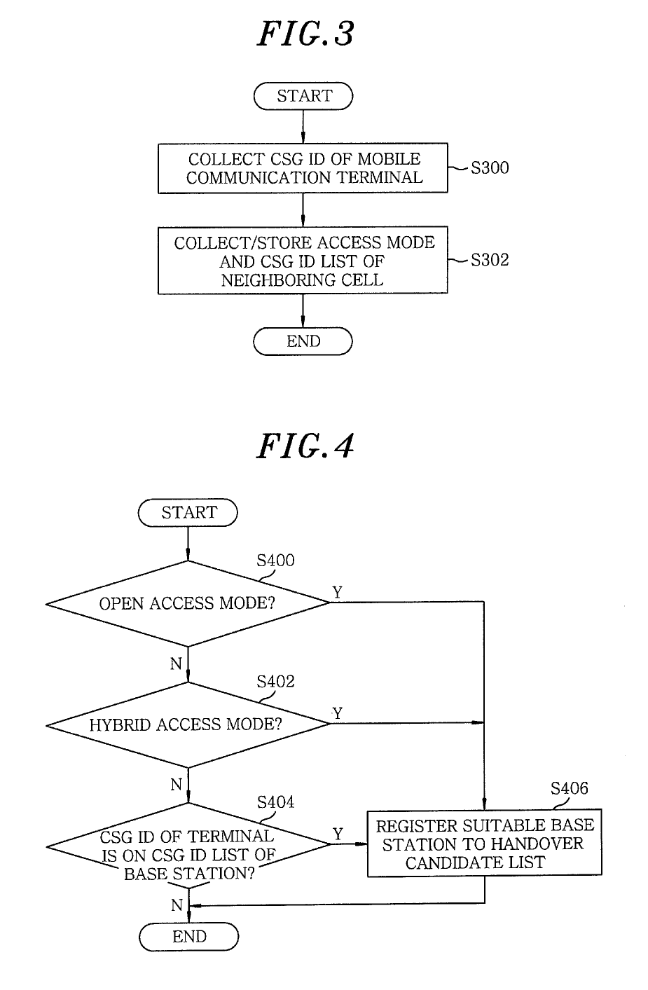

FIG. 3 is a flowchart illustrating a process of collecting, by eNodeB 100, information of the UE 102 and the eNodeB 104 within the neighboring cell, in accordance with the embodiment of the present invention. The embodiment of the present invention will now be described in detail with reference to FIGS. 1 and 3.

The eNodeB 100 requests CSG ID information of the UE 102, which provides a mobile communication service within its cell 106, to the UE 102, and receives the information therefrom in step S300.

Also, the eNodeB 100 requests the UE 102 to measure the information, e.g., the access mode and CSG ID information, of the eNodeB 104 within the neighboring cell, and collects the same in step S302.

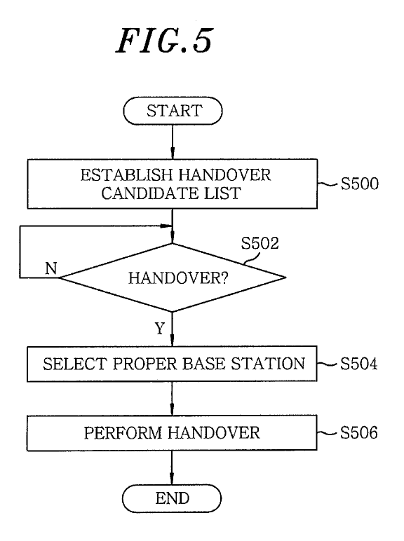

FIG. 4 is a flowchart illustrating a process of making, by the eNodeB 100, a handover candidate list of a neighboring cell suitable for handover of the UE (102), in accordance with the embodiment of the present invention. The embodiment of the present invention will now be described in detail with reference to FIGS. 1, 3, and 4.

When the eNodeB 100 collects the information regarding the eNodeB 104 within the neighboring cell received from the UE 102 through the process shown in FIG. 3, the eNodeB 100 analyzes the collected information regarding the eNodeB 104 of the neighboring cell and establishes a handover candidate list suitable for handover of the UE 102.

That is, the eNodeB 100 checks an access mode of the eNodeB 104 within the neighboring cell 108 among the information regarding the eNodeB 104 in step S400, to determine whether or not the access mode of the eNodeB 104 is an open access mode.

If the access mode of the eNodeB 104 is an open access mode, the corresponding base station (eNodeB) 104 allows a connection of every mobile communication terminal. Thus, the eNodeB 100 determines that the eNodeB 104 of the neighboring cell 108 whose access mode is an open access mode is suitable for handover of the UE 102, and registers the eNodeB 104 in the handover candidate cell list in step S406.

Subsequently, the eNodeB 100 checks an access mode of the eNodeB 104 within the neighboring cell 108 among the information regarding the eNodeB 104 in step S402, to determine whether or not the access mode of the eNodeB 104 is a hybrid access mode.

When the access mode of the eNodeB 104 is a hybrid access mode, the corresponding base station (eNodeB 104) allows a connection of every mobile communication terminal but gives more priorities to a UE whose CSG ID exists in the CSG ID list of the eNodeB 104 than other UEs in terms of a connection or a resource allocation.

Thus, because the eNodeB 104 in the hybrid access mode also allows an access by every mobile communication terminal, the eNodeB 100 determines that the eNodeB 104 of the neighboring cell 108, whose access mode is a hybrid access mode, is suitable for handover of the UE 102 and registers the eNodeB 104 in the handover candidate cell list in step S406.

Meanwhile, when the eNodeB 100 checks an access mode of a base station of a neighboring cell, if an access mode of the base station is a closed access mode, the corresponding base station allows an access by only a UE having the same CSG ID as that in its CSG ID list, so the eNodeB 100 checks whether or not the CSG ID of the UE exists in the CSG ID list of the corresponding base station (eNodeB) 104.

Namely, the eNodeB 100 checks the CSG ID list of the eNodeB 104 among the information regarding the eNodeB 104 within the neighboring cell 108 to determine whether or not the CSG ID of the UE 102 is in the CSG ID list of the eNodeB 104 in step S404. When the CSG ID of the UE 102 exists in the CSG ID list of the eNodeB 104, the eNodeB 100 determines that the eNodeB 104 is suitable for handover of the UE 102, and registers the eNodeB 104 in the handover candidate cell list in step S406.

FIG. 5 is a flowchart illustrating a process of performing, by the eNodeB 100, handover of the UE 102 in accordance with the embodiment of the present invention. The embodiment of the present invention will now be described in detail with reference to FIGS. 1, 4, and 5.

First, the eNodeB 100 establishes a handover candidate list by using base station information suitable for handover of the UE 102 registered through the process illustrated in FIG. 4 in step S500.

In this way, after establishing the handover candidate list with respect to the UE 102, the eNodeB 100 checks whether or not handover of the UE 102 is required in step S502.

If forceful handover of the UE 102 is required because of load balancing within the cell of the eNodeB 100 or expiration of a temporary CSG ID usage term, the eNodeB 100 selects a proper base station from the handover candidate list composed of neighboring cells allowing a handover connection of the UE 102 in step S504.

Lastly, the eNodeB 100 performs handover of the UE 102 to the selected base station in step S506. In this manner, the handover candidate list composed of neighboring cells allowing a handover connection is established in advance to prevent handover of the UE 102 from being rejected by a target cell, thus ensuring stable handover.

As described above, in the present invention, when the small base station apparatus performs cell searching for handover of a mobile communication terminal, it receives base station information of a neighboring cell received from a mobile communication terminal belonging to its cell, checks whether or not the base station allows handover of the mobile communication terminal, makes a handover candidate list suitable for handover of the mobile communication terminal, selects one of the base stations included in the handover candidate list, and performs handover of the mobile communication terminal. As a result, suitable handover can be performed.

While the invention has been shown and described with respect to the embodiments, it will be understood by those skilled in the art that various changes and modification may be made without departing from the scope of the invention as defined in the following claims.

What is claimed is:

1. A small base station apparatus, comprising:
a communication unit for collecting system information of a neighboring cell through mobile communication terminals being connected to a cell of the small base station apparatus;
a memory unit for storing the system information of the neighboring cell; and
a controller for checking whether or not a mobile communication terminal is allowed a handover connection to the neighboring cell based on the system information of the neighboring cell, registering the neighboring cell in a handover candidate list of the mobile communication terminal if the mobile communication terminal is allowed the handover connection, selecting one of neighboring cells registered in the handover candidate list, and performing handover of the mobile communication terminal to the selected neighboring cell.

2. The small base station apparatus of claim 1, wherein the small base station apparatus operates in one of an open access mode, a closed access mode and a hybrid access mode, wherein the apparatus, in the open access mode, does not have a closed subscriber group (CSG) ID list and allows an access by every mobile communication terminal, the apparatus, in the closed access mode, has a CSG ID list and allows an access by a mobile communication terminal only when a CSG ID of the mobile communication terminal exists in the CSG ID list of the apparatus, and the apparatus, in the hybrid access mode, has a CSG ID list but allows an access by every mobile communication terminal.

3. The small base station apparatus of claim 2, wherein the small base station apparatus acquires the CSG ID of the mobile communication terminal from the mobile communication terminal.

4. The small base station apparatus of claim 1, wherein the controller requests the mobile communication terminals being connected to the small base station apparatus to collect the system information of the neighboring cell, and collects and stores the system information of the neighboring cell measured by the mobile communication terminals.

5. The small base station apparatus of claim 4, wherein the controller requests mobile communication terminals in a non-call state among the mobile communication terminals being connected to the small base station apparatus to measure and report the system information of the neighboring cell.

6. The small base station apparatus of claim 4, wherein the neighboring cell is included in an area where the mobile communication terminal can receive the system information.

7. The small base station apparatus of claim 1, wherein the system information of the neighboring cell contains an access mode and CSG ID list information of the neighboring cell and is being periodically broadcasted through cell broadcast information.

8. The small base station apparatus of claim 1, wherein when an access mode of the neighboring cell is an open access mode or a hybrid access mode, the controller registers the neighboring cell in the handover candidate list.

9. The small base station apparatus of claim 1, wherein when an access mode of the neighboring cell is a closed access mode, if a CSG ID of the mobile communication terminal exists in a CSG ID list of the neighboring cell, the controller registers the neighboring cell in the handover candidate list.

10. The small base station apparatus of claim 1, wherein the controller measures a load state of the small base station, and when it is determined that load balancing is required based on the load state, the controller performs forceful handover of the mobile communication terminal to the neighboring cell.

11. The small base station apparatus of claim 1, wherein the controller performs forceful handover of a mobile communication terminal whose CSG ID usage term expires, among the mobile communication terminals being connected to the small base station, to the neighboring cell.

12. A method for searching a cell for handover in a small base station apparatus, the method comprising:
collecting system information of a neighboring cell through mobile communication terminals being connected to a cell of the small base station apparatus;
storing the system information of the neighboring cell;
establishing a handover candidate list for handover of a mobile communication terminal based on the system information of the neighboring cell; and
selecting, when a handover event with respect to the mobile communication terminal occurs, one of neighboring cells registered in the handover candidate list, and performing handover of the mobile communication terminal to the selected neighboring cell.

13. The method of claim 12, wherein said collecting the system information includes:
requesting the mobile communication terminals being connected to the cell of the small base station apparatus to collect the system information of the neighboring cell; and
receiving the system information of the neighboring cell from the mobile communication terminals.

14. The method of claim 13, wherein mobile communication terminals in a non-call state, among the mobile communication terminals being connected to the cell of the small base station apparatus, are requested to measure and report the system information of the neighboring cell.

15. The method of claim 12, wherein the system information of the neighboring cell contains an access mode and CSG ID list information of the neighboring cell and is being periodically broadcasted through broadcast information of the neighboring cell.

16. The method of claim 12, wherein said establishing the handover candidate list includes:
checking whether or not the neighboring cell allows handover of the mobile communication terminal based on the system information of the neighboring cell; and
if a result from said checking is affirmative, registering the neighboring cell in the handover candidate list for handover of the mobile communication terminal.

17. The method of claim 16, wherein when an access mode of the neighboring cell is an open access mode or a hybrid access mode, it is determined that the neighboring cell allows handover of the mobile communication terminal.

18. The method of claim 16, wherein when an access mode of the neighboring cell is a closed access mode, if a CSG ID of the mobile communication terminal exists in a CSG ID list of the neighboring cell, it is determined that the neighboring cell allows handover of the mobile communication terminal.

19. The method of claim 12, wherein when it is determined that load balancing is required based on a load state of the small base station, forceful handover of the mobile communication terminal to the neighboring cell is performed.

20. The method of claim 12, wherein forceful handover of a mobile communication terminal whose CSG ID usage term expires, among the mobile communication terminals, to the neighboring cell is performed.
